(19) United States
(12) Patent Application Publication
(10) Pub. No.: US 2004/0243498 A1
(43) Pub. Date: Dec. 2, 2004

(54) Interest bearing gift card mechanisms

(76) Inventor: Harry Duke, Englewood, NJ (US)

Correspondence Address: Schwegman, Lundberg, Woessner & Kluth, P.A., P.O. Box 2938, Minneapolis, MN, 55402, US

(21) Appl. No.: 10/811,605

(22) Filed: Mar. 29, 2004

Related U.S. Application Data
(63) Continuation-in-part of application No. 10/298,036, filed on Nov. 15, 2002.
(63) Continuation-in-part of application No. PCT/US03/36527, filed on Nov. 14, 2003.

(51) Int. Cl. G06F 17/60

(52) U.S. Cl. 705/35

(57) ABSTRACT

An interest bearing gift card (“IBGC”) and related methods and systems are compatible with various credit and debit card networks and may be employed almost universally. An account associated with the IBGC is credited on a predetermined basis with transaction related credits reflecting an effective monetary return on amounts maintained in the IBGC account. Funds in the IBGC account may be allocated between multiple investment sub-accounts, such as stock and bond funds. The value of the IBGC account is the sum of the net asset value of all sub-accounts. Filters may be applied to transactions to prevent undesired transactions with selected merchants, or transactions exceeding a specified amount.

### RELATED APPLICATIONS

This application is a continuation-in-part under 37 C.F.R. 1.53(b) of U.S. patent application Ser. No. 10/298,036 filed Nov. 15, 2002, and also claims priority under 35 U.S.C. 120 or 365(c)to PCT Application No. PCT/US03/36527 filed Nov. 14, 2003, both of which are incorporated herein by reference and made a part hereof.

### FIELD OF THE INVENTION

The present invention relates to gift cards, and in particular to an interest bearing gift card (“IBGC”) and related methods and systems for using such a card.

### BACKGROUND OF THE INVENTION

Estimates suggest that, in 2001, Americans generated 21.05 billion credit card transactions, 10.47 billion debit card transactions and 29.15 billion payments by check. “The Check Isn't In The Mail: Credit and Debit Cards Tear Into Paper as Payment Methods,” May 1, 2002, The Wall Street Journal. The United States Department of Commerce estimates that Americans spent $2,122.00 billion at a seasonally adjusted annual rate for non-durable goods during August 2002. And the Federal Reserve estimates that Americans had $1,730.20 billion of revolving and non-revolving debt outstanding as of Aug. 30, 2002. In 1968, when the Fed began this series, Americans had $1.30 billion of revolving debt outstanding.

The ever-declining cost of computer power, storage, data transmission and data manipulation explain why plastic has been increasingly replacing cash to conduct purchase transactions. As those costs decline, purchase authorization systems and industry oversight efforts have become more advanced and much more efficient. Because of the technological advances, the American consumer has replaced his wallet's limited amount of cash with a nearly limitless amount of credit available for purchases, be they planned or made on impulse.

From the retailer's side, what began humbly enough as the paper gift certificate, a service convenience that helped ensure the future sale would benefit the merchant, has grown into a huge business of retailer-specific plastic wallet-sized charge cards, credit cards and gift cards.

From the bank card issuer's side, what began in March 1950 as Diner's Club, the service to process travel and expense charges so cash would not be required at the time service was incurred, has grown into a hugely important revenue and profit source of America's bank and non-bank financial institutions alike where purchase authorization systems benefit the card issuer, the merchant and the cardholder.

Banking institutions often issue debit cards to their customers to give them access to funds from their savings or checking accounts. Such debit cards might be-on-line or off-line. On-line debit cards, often referred to as automatic teller machine (ATM) cards, require a personal identification number (PIN) to be entered into an ATM or point-of-sale (POS) device in order to authorize the transaction. Once completed, the transaction clears the bank account immediately. Off-line debit cards function like credit cards, and usually carry the VISA® or MasterCard® service mark. A retailer processes the card like a credit card and the customer signs a receipt. The funds then clear the bank account in one to three days.

One form of debit card is known as a “Smart Card”, as disclosed in United States Patent Application Pub. No. US2001/0047342 A1 (“'342 Application”). A Smart Card is an electronic device that typically includes a micro processing unit or CPU and a memory suitable for encapsulation within a small flexible plastic card, for example, one that is about the size of a credit card. The smart card additionally includes some form of an interface for communicating with an external system. Smart Cards are also disclosed in the U.S. Pat. Nos. 5,955,961; 4,959,788; and 5,777,903. Smart Cards, such as those disclosed in the '342 Patent, are not associated on a real-time basis with a banking computer system. When a Smart Card is used in a transaction by way of processing through a POS device, the POS device reads only such data as is stored on the Smart Card account balance chip.

As further disclosed in the '342 Application, Smart Cards may be employed as “Gift Cards”. A Gift Card donor can establish a debit card account with an associated fixed sum with a bank or retail institution; the fixed sum is reflected in data programmed into the chip of a Smart Card provided to the donee by the bank or retail institution. Another example of a gift card is disclosed in U.S. Pat. No. 6,189,787 B1 (“'787 Patent”). The '787 Patent discloses a multifunctional card system whereby a retail institution can, through a central banking system computer hub, credit a fixed amount to a card for purposes of using that card in a retailer's stores. The card thereby functions as an electronic gift card specific to a certain retailer.

There are numerous permutations of credit cards available, many of which share a merchant fee and offer incentives to the cardholder such as frequent flier miles, charitable donations to a cause of the cardholder's choice, cash rebates, low interest rates on balances maintained for more than one month, and even insurance for purchases. However, these card systems do not, in compliance with relevant banking laws, facilitate the crediting of supplementary amounts reflecting an effective monetary return on amounts maintained in an account associated with either a credit card or an electronic gift card.

### SUMMARY OF THE INVENTION

An Interest Bearing Gift Card (IBGC) is compatible with and acceptable for use on existing card transaction networks. Available credit, ie, the amount deposited plus accrued interest, is assumed to be invested in one account. In another embodiment, the IBGC available credit may be allocated among multiple interest bearing sub-accounts, such as short-term bond funds, intermediate-term bond funds and long-term bond funds, for the sole purpose of increasing the amount of interest the cardholder can earn during the life of the IBGC. An IBGC's account value would equal the sum of all sub-account values at any point in time.

In one embodiment, the IBGC's initial available credit may be sourced via -cash, check, money order, debit or credit card, bank demand, Negotiable Order of Withdrawal (NOW), savings or even certificate of deposit accounts. Additionally, telephone transfers and Internet transfers would be available.

In one embodiment an investment component is added to existing card networks and systems such as the VISA®, MasterCard®, Discover® and American Express® card networks.

In one embodiment, during use, the IBGC is swiped through a seller's pre-existing, standard retail point of sale (POS) device to transmit IBGC data to an IBGC sponsor processing hub computer under IBGC sponsor software control and in communication over a banking debit network with the POS device. The IBGC data comprises (i) unique IBGC identification information including a number approved by the American Banking Association for use in a banking debit network and (ii) a transaction amount. An IBGC account database corresponding to the IBGC and maintained on the IBGC sponsor processing hub computer is thereby accessed. The IBGC account database comprises balance data representative of (1) the sum of an IBGC account activation amount and transaction related or investment credits accrued by the IBGC account, less (2) amounts of previous transactions. The difference between the transaction amount and the IBGC balance data is calculated using the IBGC sponsor processing hub computer and (i) if such difference is a sufficiently large positive number, data is transmitted from the IBGC sponsor processing hub computer to the POS authorizing said transaction, or (ii) if such difference is not a sufficiently large positive number, data is transmitted from the IBGC sponsor processing hub computer to the POS denying the transaction.

The IBGC account database is updated using the IBGC sponsor processing hub computer to transmit data to the IBGC account database reflecting (i) the subtraction from the IBGC balance of the amount of an authorized transaction, and (ii) the addition to the IBGC balance of IBGC transaction related or investment credits from the multiple investment sub-accounts.

In a further embodiment, filters may be applied to transactions to prevent undesired transactions with selected merchants, or transactions exceeding a specified amount. When the IBGC is purchased, these filters may be selected, and parameters specified. A selected maximum dollar amount for transactions may be specified for a purchase limit filter. Selected merchants, or categories of merchants where transactions are permitted, or not permitted, may be specified by use of a merchant filter. The filters may be used separately, or multiple filters may be used for an IBGC or other type of financial card.

### BRIEF DESCRIPTION OF THE DRAWINGS

FIGS. 1A, 1B, 1C, 1D, 1E, 1F and 1G illustrate the flow of information relating to an IBGC transaction in one embodiment of the instant invention.

FIG. 2 illustrates a block diagram of the interrelationship of retail POS devices and various hub computers and associated accounts used in connection with the methods and systems of the instant invention.

FIG. 3 illustrates a block diagram demonstrating the flow of funds in an IBGC system of the present invention.

FIG. 4 is a flowchart illustrating a method for access, modification or creation of filter parameters.

FIG. 5 is a block diagram of an IBGC account with sub-accounts according to one example embodiment of the invention.

FIG. 6 is a block flow diagram of an example flow of funds in an IBGC account having sub-accounts according to one example embodiment of the invention.

### DETAILED DESCRIPTION

The IBGC and related methods and systems of the instant invention are subject to the following conditions or definitions:

The IBGC and all elements of its use are subject to terms and definitions laid out in the IBGC holder's agreement, which is not attached to the IBGC and which is subject to change over time.

Upon receipt of a new IBGC, the IBGC holder's initial telephone communication with the IBGC issuer signals his agreement with all of the IBGC holder's terms and definitions, which can change over time.

During its existence, the IBGC remains the property of the IBGC issuer.

Point of Sale Device—(POS)—A device designed to read and transmit magnetic strip information contained on the back of a debit card, credit card (or IBGC), along with appropriate merchant identification and purchase tracking information, so purchase transaction can be authorized at point of sale and merchant's risk of nonpayment can be reduced to nearly zero. The IBGC methods and systems of the instant invention use existing banking networks or other financial card networks to access virtually all existing POS devices. These include stand-alone POS terminals, cash registers with POS interfacing, computers with POS interfacing, and other similar devices that can be used to access the banking system. As used herein, POS device includes all such devices, whether data entry is affected by swiping a card through the device or by manual entry.

To utilize POS devices in connection with transactions involving methods and systems of the instant invention, an IBGC sponsor bank must apply for and obtain a Bank Identification Number (BIN) from the American Banking Association. The BIN serves as a unique identifier of the IBGC system within the banking network. The BIN is encoded on a magnetic strip on each IBGC in the system as a part of the card's identification number. The BIN comprises at least some of the requisite IBGC identification information necessary to access an IBGC account. Alternatively or additionally, the BIN and identification number could be encoded as a bar code, embossed on the surface on the IBGC in numerals for manual entry, or provided by any other means known in the art.

In one embodiment, the BIN is fifteen or sixteen digits long and begins with a digit recognized as a starting digit for BIN's used in the VISA® (starting digit of 4), MasterCard® (starting digit of 5), American Express(® card, Discover® card or other established, world-wide card systems. By using one of these numbers, the IBGC will be recognized by almost all existing POS devices without any need to reprogram such devices to recognize the IBGC. Further, conforming the BIN of IBGC to preexisting BIN digit sequences ensures data associated with transactions within IBGC system will be transferred in an acceptable manner through existing banking networks. Of course, when an IBGC component is added in accordance with the instant invention to an existing credit card, such as a card issued by VISA®, MasterCard® or American Express® card networks, the existing card identification should suffice for purposes of card identification.

Magnetic strip—The dark strip on the back of a debit card, credit card or IBGC that is swiped through a POS at time a purchase authorization is requested. It contains the following information:

1. Routing and cardholder account number:

a) 16-Digit Card—account number, read from left to right, comprised of a six-digit network (VISA®, MasterCard®, Discover®) and issuer routing number and a ten-digit cardholder account number.

b) 15-Digit Card—American Express®'s version. One less digit is used because its system was created earlier than the other three. It is not capacity constrained.

2. Card expiration date.

3. Cardholder name.

4. A portion of the strip is currently unused. It is available for encryption and security method needs that are under development.

Time is defined as being one of four distinct measurements:

1. T=0—present time.

2. T=0+1—a time interval ranging from three seconds to as long as three minutes, or the necessary amount of time required to allow communication with and authorization from the IBGC issuer's authorization system. Any interval of time greater than three minutes results in an automatic failure to authorize and requests the merchant to initiate the process again.

3. T=0+1+that night—Hours following a successful purchase authorization, between 12 AM-2 AM per time zone during which IBGC issuer's account files are updated.

4. T=26, 27, 28, or 29—Time during which IBGC customer file account information is updated for special routine events and marketing efforts, which include a) posting of interest, posting of promotional offers and benefits, the creation and mailing of IBGC account statements. The actual number depends on IBGC defined grace period.

Debit card—A payment system that allows cardholder to purchase goods and withdraw available funds from his or her demand account, NOW account or savings account to service the purchase.

Smart card—A payment system that allows cardholder's available credit to be imbedded or stored via an encrypted microchip so purchase authorization may be conducted without the need for card issuer communication and authorization. Smart cards have many applications and have become widely adopted in France but adoption in the United States has been extremely slow. Two reasons for Americans' lack of acceptance: no interest on the part of the consumer and no adoption on the part of the merchant. Merchants have been slow to adopt smart cards because smart cards require separate and more expensive POS card readers.

Proximity card—A payment system that allows cardholder to more carefully encrypt his or her identifying information at time of purchase. Such systems are designed for purchase transactions made from a customer's personal computer to merchant via the Internet. The American Express® Blue Card® is the first of its kind. Consumers have discerned very little benefit from this product and thus its adoption has been slow.

“IBGC activation amount” and “transaction related or investment credits” mean, respectively, the amount of funds credited to an IBGC account upon creation of the account and the amount of funds credited to an IBGC account subsequent to IBGC account creation as a result of IBGC use.

The following hardware and software, which are merely illustrative and in no way limiting, can be employed to operate an IBGC system and its various components. For example, the various IBGC system hub computers described hereinafter could be mainframe computers (e.g., an IBM Application Starterpac 3000 model A20) and could use an operating system such as OS/390 and MVS/ESA that runs a relational database (e.g., DB2 type database). Hub computer software could include IBM COBOL, CICS languages along with IBM's CSP screen generation language. For such a system, memory requirements are satisfied with 768 Gigabytes of storage (preferably, e.g., 1024G with a disk storage and recovery system, such as RAID). Communications generally are run on a mixed SNA and TCP/IP network. Communications with a local area network via a local control unit can be implemented using a token ring. Connection to an internal network could be made via an IBM open systems adapter (OSA) running TCP/IP, which allows File Transfer Protocol (ftp) via a firewall. Bisynchronous and synchronous file transfer protocols could be made through various dial-up media. Ethernet local area network, using an SAA gateway, and other gateways (e.g., Cytrix and Netsoft) for remote access, could also be employed.

Two IBGC perspectives are considered: what happens from the customer's side and what happens from the card issuer's side. The card issuer is expected to include bank and non-bank financial institutions that have business relationships with and thus access to the VISA®, MasterCard®, Discover® or American Express(& card networks and processing systems.

From the customer's perspective, a giftor applies for an IBGC in his or her name or that of the intended giftee. The giftor completes an application to provide the IBGC issuer with information necessary for the IBGC issuer to create and forward the IBGC to the intended giftee. Completing the application should be expected to take place using any of the following venues: at the card issuer's office, branch or retail store, over the phone, by mail or via the Internet. Regardless of the selected venue, the application process is the same: giftor completes an application, the funding balance or “the amount of the gift” is transferred to the IBGC issuer, an IBGC account is created, the IBGC itself is created and forwarded to the giftee.

From the IBGC's issuer's perspective, the IBGC application is used to create a new and unique IBGC account number. That IBGC account number would be either 15 digits or 16 digits in length. The IBGC account number, shown on the card itself, would actually comprise two identifiers necessary for today's card systems processing, the card issuer's routing number (the first six digits when reading from left to right) and the IBGC's account number (the remaining ten digits). American Express® systems are older than VISA®, MasterCard®, and Discover® and thus rely on a 15-digit routing/account number system.

Like credit cards today, the back of the IBGC would contain a magnetic strip that holds the following information, again, to make it compatible for processing on today's credit card and debit card readers: the IBGC's routing number, cardholder's account number, IBGC's expiration date, and cardholder's name.

The IBGC and all elements of its use would be subject to terms and definitions laid out in the cardholder's agreement, which would be forwarded to the giftee along with the new IBGC. The IBGC holder's required initial telephone contact with the IBGC card issuer signals his agreement with the IBGC's issuer's terms and definitions, all of which can change over time.

An IBGC application would request the IBGC giftor to provide personal information about himself and the giftee. Such information would include the following: name, home address, home telephone, business address, business phone, social security number, date of birth, preferred e-mail address, reason for gift, requested special instructions (including a note to be sent with the IBGC, special delivery, special looking IBGC, for example). Payment for the IBGC would be highlighted, be it via cash, check, money order, credit card, debit card or some other acceptable means. The application might include language that provides the giftor an opportunity to make additional contributions to the IBGC over time or to alert the giftee that outstanding gift card balances on other non-IBGC accounts may be transferred to this IBGC soon after it is created. The tax consequences of the investment can be attributed to the giftor as both income and an additional gift, or directly to the giftee as income, provided the appropriate tax id is provided.

The IBGC issuer might also request the right to market other products to the IBGC giftor and giftee over time, ie, an opportunity to convert the IBGC into a credit card once the IBGC's initial credit balance has been depleted or a low credit threshold, $10.00 for example, has been breached. The IBGC process, by which a giftor provides information about a giftee, the reason for the gift (birthday, wedding, school or professional graduation or accreditation, anniversary, religious celebration, retirement, for example) creates an opportunity to market special products over the giftee's lifecycle, an act financial institutions have not successfully performed previously.

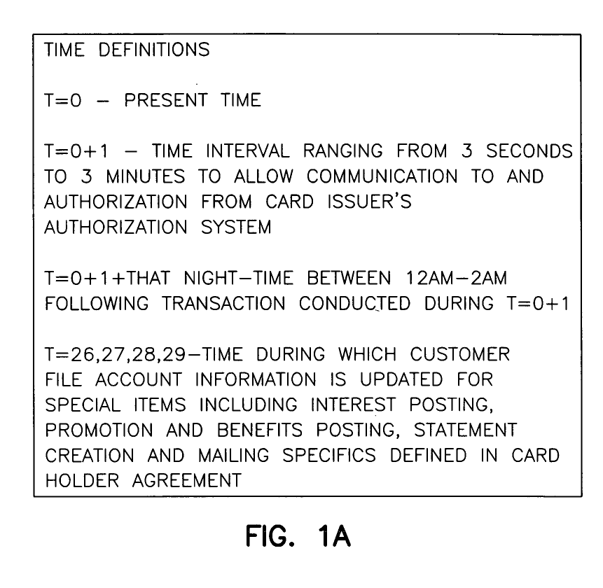

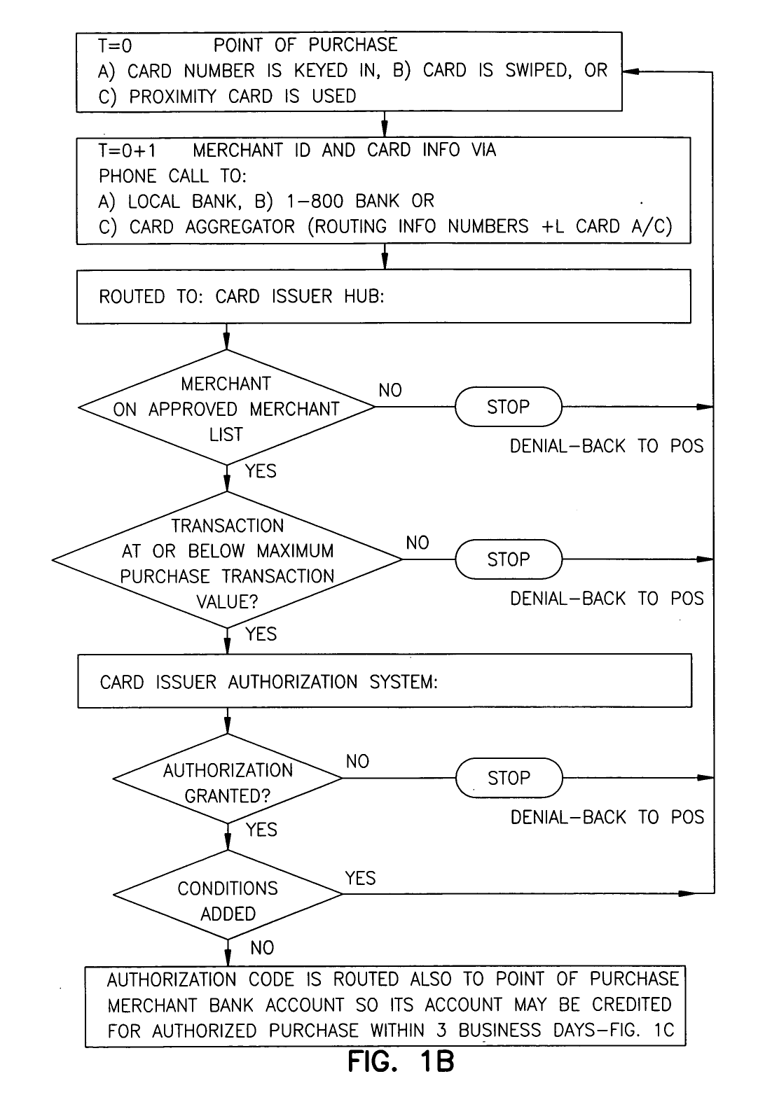

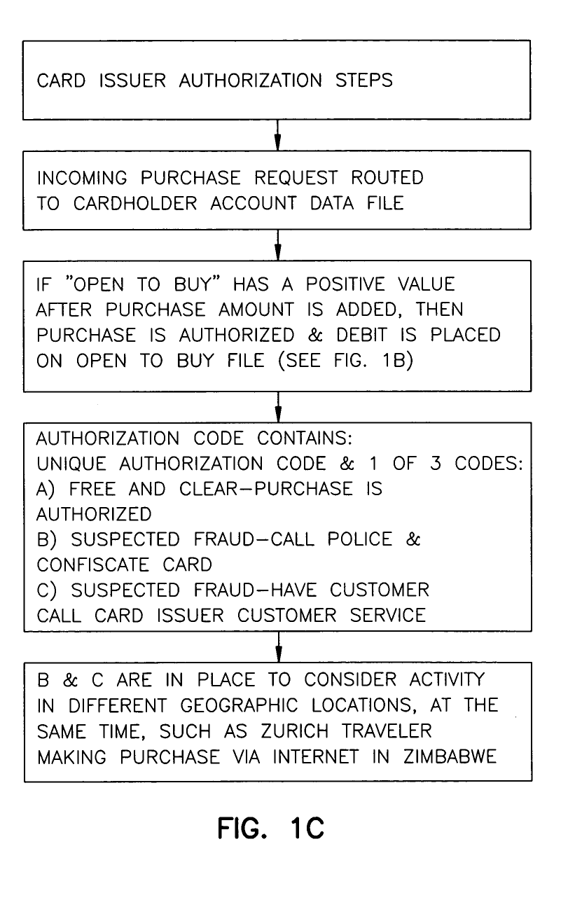

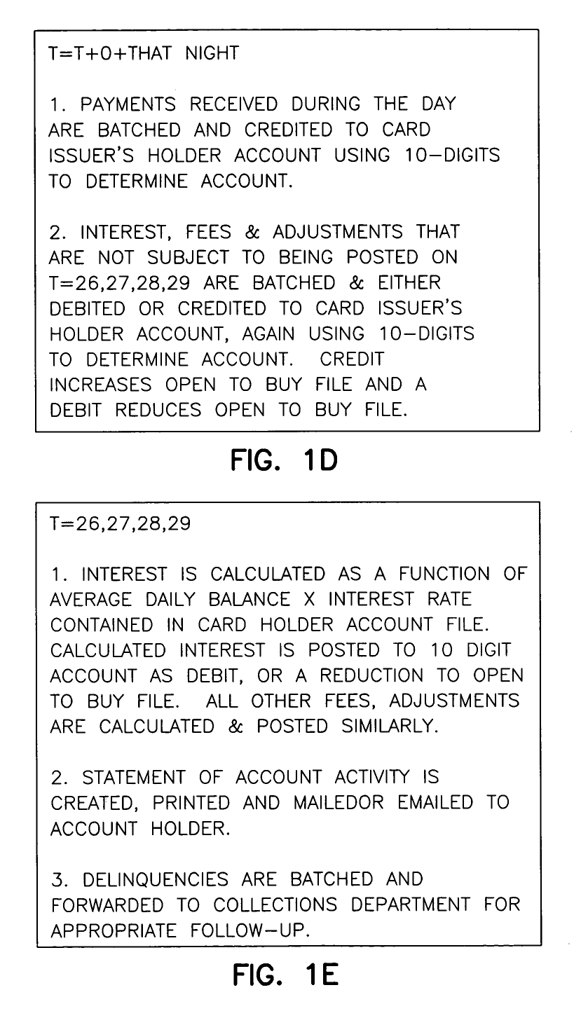

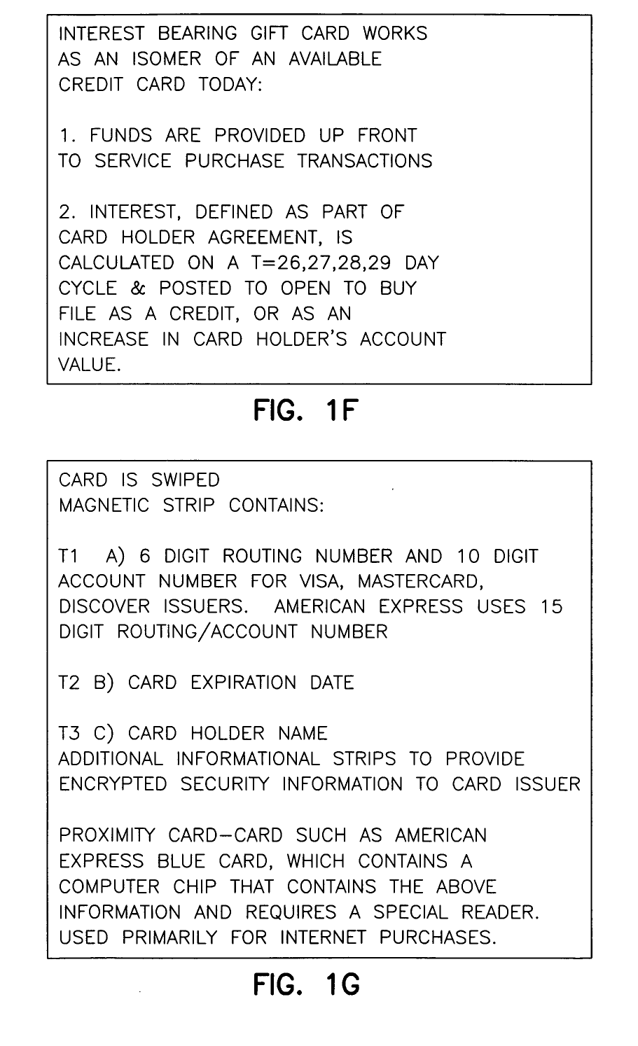

Referring to FIG. 1A, 1B, 1C, 1D, 1E, 1F and 1G, at T=0, purchase authorization process is initiated using one of three methods: keying in by hand (or via Internet) card account number to POS reader; swiping card's magnetic strip through a POS device to create and transmit purchase transaction information bundle; or using a proximity card reader with a special proximity card so purchase transaction information is encrypted and then forwarded via the Internet.

At T=0+1, STEP ONE, the merchant's POS device sends purchase transaction information bundle (comprised of cardholder information, merchant identification and purchase tracking data) via a phone connection to one of the following computer hub destinations:

Local bank (via a local phone call);

Designated bank set up to accept 1-800 phone calls;

Card aggregator (independent contractor that costs less than bank competitors).

The card issuer hub performs several optional functions in one embodiment. The functions comprise filters that may be set by the IBGC giftor, independent of the IBGC giftee. These functions may also be performed for other types of financial cards, such as bank and non-bank credit and debit cards. A first optional filter allows the selection of merchants where the card may be used. The hub compares the merchant identifier for the current transaction being requested to an approved merchant list. The approved merchant list may be in the form of individual identifiers for merchants. Merchants may also be classified into one or more of many different categories, with the approved merchant list having categories of merchants from which purchases may be made. If the merchant is not on the list, the transaction will be denied, and an indication of such is returned to the point of sale merchant. An indication will also be sent if the transaction is approved in view of the filter. This allows continued processing of the transaction as described below.

The category of a merchant from whom a purchase is attempted may also be compared to a list of approved categories. In further embodiments, the list is a list of merchants for which the IBGC may not be used.

The approved merchant list is stored in the cardholder identification file that may be checked by the hub to deny a transaction. It may be in the form of a sub-file in the cardholder identification file. In a further embodiment, all merchants at a school or all schools are included in a group, and may be selected just by selecting the group.

A further optional filter comprises placing a maximum purchase amount for a transaction on the IGBGC. In both instances, filter parameters, such as merchant lists or maximum values, are stored in the cardholder identification file that may be checked by the hub to deny a transaction. It may be in the form of a sub-file in the cardholder identification file. The purchase amount filter will allow transactions at or below a maximum purchase transaction value.

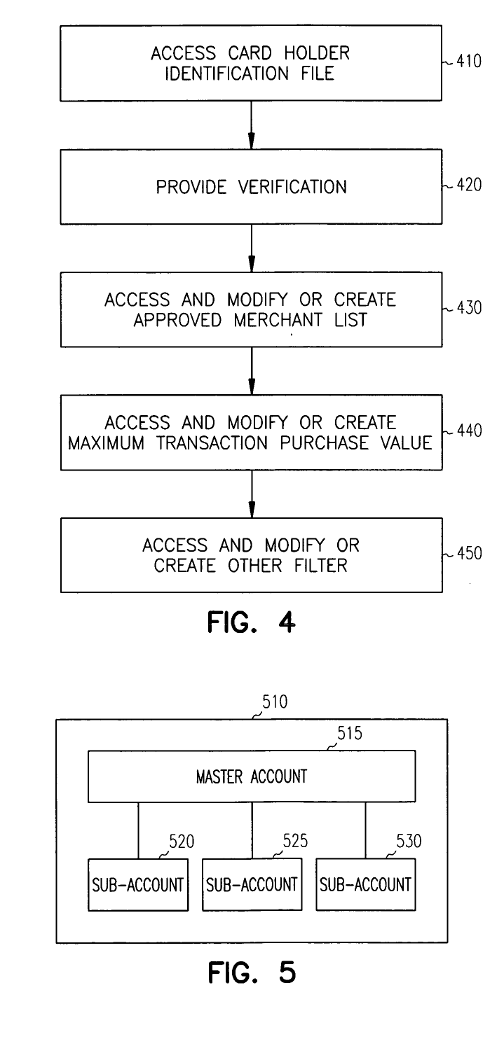

Filters, and parameters for the filters may be set by the IBGC purchaser or giftor at the time of purchase, or later by one of many different communication mechanisms. The giftor may also authorize others to modify the filters and parameters. The FIG. 4 provides a flowchart for access, modification or creation of filter parameters. If no parameters are specified, they may be given default values, or the filter may not be used.

In FIG. 4, the cardholder identification file is accessed at 410. This may be done in person at the hub, or at a location having access to the file, or via telephone, mail or on-line access to name a few mechanisms. Verification of authorization to access the file is provided at 420. If done after purchase, it may entail a password, or other form of identification, such as credit card account number or user name information. At 430, access to the file is provided, along with the ability to modify or create an approved merchant list. In the case of on-line access, lists of merchants and search functions may be provided to enable selection of merchants to add to the list. Merchants may also be removed from the list.

At 440, access is provided to modify or create a maximum transaction purchase value. This filter may be used alone, or in combination with the merchant filter. In one embodiment, the filters are combined, such that each merchant in the approved merchant list may have an associated maximum transaction purchase value.

At 450, still further filters and their parameters may be accessed. The number of filters and types of filters is unlimited.

Referring again to FIGS. 1A, 1B, 1C, 1D, 1E, 1F and 1G, at T=0+1,

STEP TWO:

Cardholder's account number is read to identify card issuer's network (VISA, MasterCard, Discover or American Express) and specific card issuer. Once identified, the POS information bundle is “routed to” or electronically forwarded to the card issuer's card authorization system for authorization approval and reply to the POS.

STEP THREE

The POS information bundle is electronically received at the card issuer's authorization system hub. A very simple Yes or No question is addressed, whether or not to authorize purchase.

POS information bundle is broken down and purchase amount request is routed to “Open to Buy” file within cardholder account data file using cardholder's ten-digit identifier. The cardholder account data file is comprised of four specific files:

Cardholder identification file.

Open to Buy file. An electronic T-account, capable of accepting debits and credits.

Benefits and promotions file.

Interest rate file.

STEP FOUR

Purchase amount request is debited to the cardholder's Open to Buy file. The cardholder's Open to Buy debits are summed and the credits are summed. Then debits are subtracted from credits. If the result is positive or zero, purchase authorization is granted and 100% of the purchase value is debited (or added) to the cardholder's Open to Buy file. An authorization code is created and electronically routed back to POS location. (See “Merchant Transaction Fee” below to learn what happens from merchant's perspective once purchase has been authorized.) If the result is negative, purchase authorization is denied and the purchase amount is not debited (or added) to the cardholder's Open to Buy file. An authorization code is created and electronically routed back to POS location.

Regardless of purchase authorization outcome, the authorization code that is routed back to POS location contains one of three service messages that are meant for merchant use for security purposes:

Free and clear—no other action need be taken by merchant.

Suspected fraud—merchant is to confiscate card and contact local police.

Suspected fraud—merchant is to request that cardholder contact card issuer customer service.

Merchant Transaction Fee

The cardholder's Open to Buy file has just posted an authorized purchase transaction. The debit shown on the cardholder's Open to Buy file equals 100% of the approved purchase value. As the card issuer's authorization code is being routed back to POS location to complete the purchase transaction, the card issuer routes another electronic authorization to the merchant's bank, one that allows the merchant to receive payment for that approved purchase within three business days.

The card issuer's merchant bank payment authorization reflects a value of less than 100% of the approved purchase value. That discount, ranging between 1.5%-3.0% of the approved purchase value, is known in the industry as the “Merchant Transaction Fee,” and is the cash amount that is retained by the card issuer to cover his costs of operating his transaction systems and affiliating his company with a large network such as VISA, MasterCard, Discover or American Express.

In recent years, credit card and debit card issuers have come to share a portion of their “Merchant Transaction Fees” with cardholders in order to create product adoption and spur card usage. The IBGC inventor envisions acting similarly to accomplish the same objectives. Such fee sharing might be labeled “Bonus interest, Bonus mileage, Bonus charitable contributions . . . .”

At T=T+0+that night, the card issuer updates cardholder accounts nightly to reflect following:

Payments received by card issuer during the day, which have been batched, are credited to the cardholder's Open to Buy file. After a payment has been credited, the cardholder's Open to Buy file net value increases by the amount of the credit.

Interest, fees and adjustments that are not subject to being posted on T=26, 27, 28, 29 are batched and either debited or credited to the cardholder's Open to Buy file. A credit increases the cardholder's Open to Buy net file value and a debit reduces it.

At T=26, 27, 28, 29, the card issuer performs four routine cardholder account operations on a monthly cycle:

Interest is calculated as a function of the Open to Buy file's average daily balance multiplied by the interest rate that is contained in the cardholder account file. Calculated interest is posted to the Open to Buy file as a debit, or as a reduction of the Open to Buy file's net value.

Other fees, adjustments, promotional offers and benefits are calculated and posted similarly.

A cardholder account statement, updated to reflect debits and credits or account activity that has been generated during previous 26, 27, 28 or 29 days, is created, printed and forwarded to the cardholder for his review.

Delinquent accounts are batched and forwarded to collections department for appropriate follow-up.

Using above detailed description for background, the novel IBGC can be understood as an “isomer” of today's credit card:

Giftor provides funds to create initial credit value of cardholder's (or giftee's) Open to Buy file.

Interest, defined within IBGC holder's agreement, is calculated on T=26, 27,28, 29 day cycle and posted as a credit to cardholder's Open to Buy file, or as a net increase in the cardholder's account value.

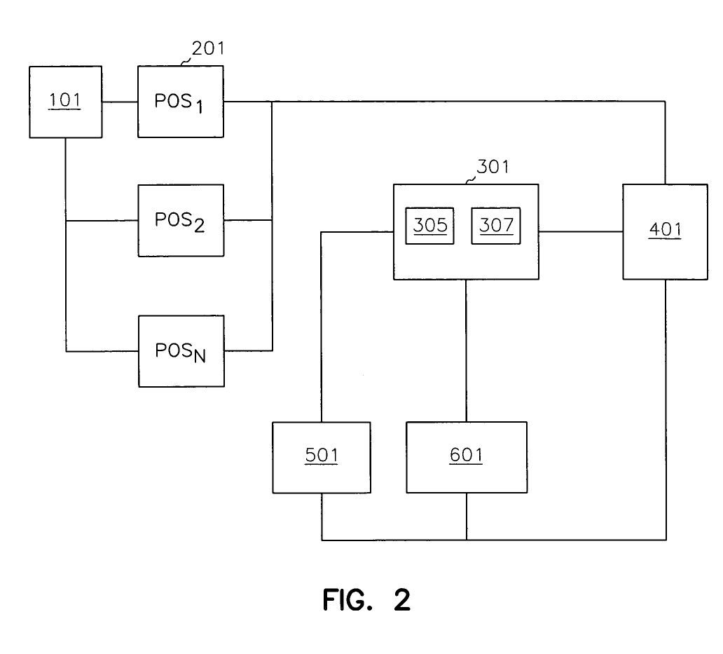

Referring to FIG. 2, during operation of the IBGC system of the present invention, one or more banks serve as IBGC sponsors and have hub computers that are in communication with one another through the banking system for the transfer of data relating to transactions involving IBGC 101. The embodiment illustrated in FIG. 2 depicts the interrelationship of one IBGC sponsor bank hub computer 301 with the various elements of IBGC system 100; IBGC system 100 can comprise numerous IBGC sponsor hub computers that operate within IBGC system 100 in the same manner as IBGC sponsor bank hub computer 301. An IBGC donor establishes an IBGC account with IBGC sponsor bank 301 for the benefit of an IBGC donee by conveying funds representing an IBGC 101 activation amount by any accepted means to IBGC sponsor bank 301. For example, the IBGC donor can convey such funds to the IBGC sponsor bank through cash deposit, check, wire transfer through a banking network or other type of financial card network, or by use of funds obtained through a card network such as VISA®, MasterCard®, Discover® or American Express® card. The IBGC donor may establish the IBGC account by direct transfer of funds to any branch 305, 307 of the IBGC sponsor bank that is in communication with IBGC sponsor bank hub computer 301 for purposes of transferring data relating to IBGC sponsor bank accounts.

Alternatively, the IBGC donor may choose to establish the IBGC account with an IBGC sponsor bank through a directive to a non-IBGC sponsor bank 501, 601 to transfer funds representing an IBGC 101 activation amount, by fed funds wire, sweeps of funds from other accounts, by check or other means of transferring funds, through a banking network 401 to the IBGC sponsor bank hub computer 301. This flexibility enhances the appeal of the system of the instant invention in that donors who may not have ready access to sponsor bank branches can nonetheless establish an IBGC account through their own local bank.

As discussed, traditional identification information useful in banking systems, such as the name, address, social security number, and date of birth of the IBGC account donor and cardholder, is compiled at the time the IBGC account is created. The IBGC cardholder is given the option of transferring balances from other bank or IBGC accounts to the newly created IBGC account. Further, upon creation of the IBGC account, the IBGC cardholder is made aware of all relevant parameters regarding the account, including, e.g., how the daily average balance is calculated, the number of allowable transactions per month, the availability of bonuses, and the consequences of exceeding the account balance at any particular time.

As a security measure, IBGC systems of the instant invention account for the possibility of lost and stolen cards by enabling the immediate deactivation of any particular IBGC card and the reissuing of a new IBGC card and account number to any cardholder.

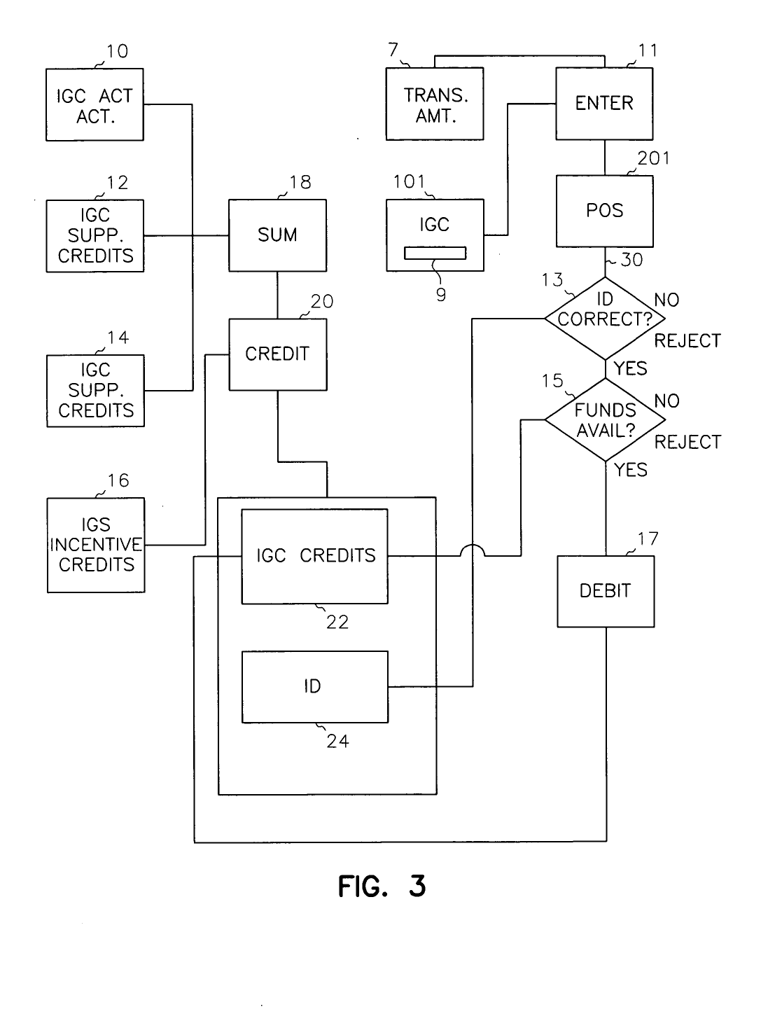

Referring to FIG. 3, a flowchart of funds transferred in connection with a transaction using an IBGC in accordance with the instant invention is illustrated. Funds are credited 20 to an IBGC account 22 under the control of IBGC sponsor bank 25 from at least three sources: an IBGC activation amount 10, IBGC supplementary credit amounts 12 and IBGC supplementary (post-IBGC activation) deposits 14. IBGC activation amount 10, IBGC supplementary credit amounts (e.g., interest or investment income distribution amounts) 12, IBGC supplementary (post-IBGC activation) deposits 14 are summed 18 and credited 20 together with IBGC incentive credits 16 to IBGC account 22. IBGC incentive credits 16 may be credited 20 by IBGC sponsor bank 25 as a customer loyalty incentive or for any other permissible reason.

In a transaction, IBGC 101 is presented by an IBGC cardholder and IBGC account identification data 9 and transaction amount 7 are entered 11 into POS 201 that is a standard POS device in communication over a banking network 30 with IBGC sponsor bank 25. IBGC 101 identification information 9 is compared 13 with IBGC account identification information 24. (Requisite IBGC account identification information may comprise more than the information contained in IBGC 101 identification information 9; such information could include, e.g., IBGC cardholder's mother's maiden name and such information could be transmitted to IBGC sponsor bank 25 by the party transacting with the presenter of the IBGC 101 by telephone or other means.) If IBGC 101 identification information 9 matches IBGC account identification information 24 a comparison 15 of transaction amount 7 and IBGC account credits 22 is made to determine if sufficient funds are available to cover the transaction amount 7. If sufficient funds are available, the transaction is approved and transaction amount 7 is debited 17 from IBGC account credits 22. In this example, which is illustrative and by no means limiting, a substantial percentage of the transaction amount 7 (e.g., 97%) is credited electronically to the transacting party within a fixed period, e.g., three days. The balance of the transaction amount 7 (e.g., 3%) is credited according to a contractually specified formula to both the IBGC account credits 22 and an account of IBGC sponsor bank 25.

In a further embodiment illustrated in FIG. 5, an IBGC account 510 is comprised of a master account 515, which is capable of recording debits and credits. The master account includes a variable number of sub-accounts, three of which are shown at 520, 525 and 530. These sub-accounts are also capable of recording debits and credits. The number of sub-accounts may be many more than three, and may even be a single sub-account in further embodiments.

The sub-accounts provide for the IBGC giftee's available credit to be invested across a range of investment choice to increase the master account's total earning potential. For example, assume an IBGC is created and $5,000 is credited to the master account 515. In this embodiment, a portion of available credit is invested in sub-account 520, a money market fund, which may be drawn upon immediately to service purchases made by the IBGC giftee, and other portions of available credit, may be invested in an intermediate-term bond fund and a long-term bond fund in sub-accounts 525 and 530. Each of the sub-accounts may have further sub-accounts in one embodiment, organized in a hierarchy of different types of funds, such as bond funds, including intermediate term or duration, long-term, tax advantaged, and inflation indexed bond funds.

The number and type of available sub-accounts are unlimited in one embodiment, and may correspond to the variety of investments available through large brokerage houses, commercial banks or nonbank financial intermediaries. In one embodiment, up to ten or more money market funds, six short-term bond funds, nine intermediate-term bond funds, one inflation-indexed bond fund and twelve long-term bond funds are included. Taxable and tax-advantaged interest bearing funds are also available to the IBGC giftee.

The above embodiment applies to bank and non-bank debit and credit card issuers, regardless of where they are based or domiciled. Moreover, the above embodiment applies to bank or non-bank debit and credit card issuers who allow for the investment of IBGC credit to another bank or non-bank asset custodian.

In one embodiment, at least one sub-account category is cash equivalent; a highly liquid, high quality interest bearing security, with a maturity (based on date of purchase) of three months or less. Included in this category are securities issued by the US government, its agencies and instrumentalities, repurchase agreements (other than equity repurchase agreements), certificates of deposit, bankers' acceptances, commercial paper (rated in one of the two highest rating categories), variable rate master demand notes, money market mutual funds and bank money market deposit accounts.

The value of the IBGC sub-accounts may be determined on a frequent basis, say daily, by sub-account's Net Asset Value (NAV). In further embodiments, the value is determined using Net market portfolio (or fund) value, the difference between the market value of the portfolio's assets less its liabilities. NAV would be calculated by dividing total net market portfolio value by the portfolio's or fund's number of outstanding shares. Currently, in the US, a fund's NAV is calculated each business day as of 4:00 PM ET (at market close). This time may be later, or may be earlier, such as when trading markets close earlier. In further embodiments, where markets may not close, NAV may be calculated at a predetermined time or times during a day.

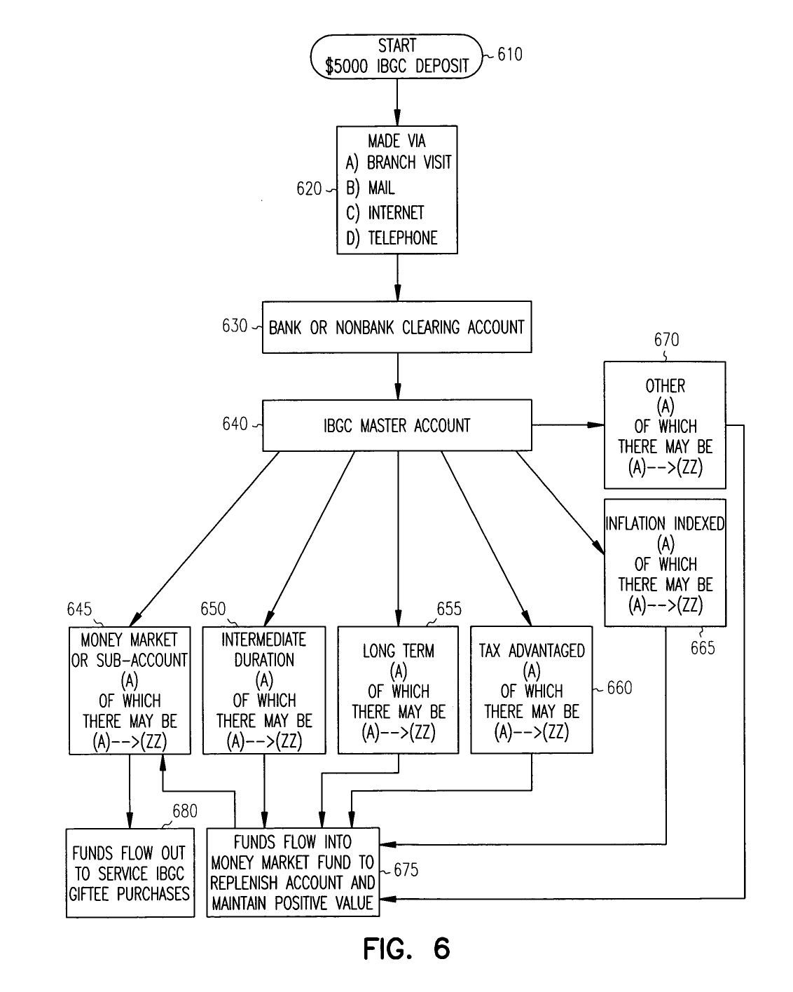

IBGC initial or “renewing” credit deposits are invested wholly in one portfolio, one fund or one investment pool in one embodiment of the present invention. A Flow of funds example among IBGC sub-accounts is presented in FIG. 6. Assume $5,000 (US) is deposited at 610. This deposit may be an initial deposit to a newly established IBGC account, it may be a renewal or an addition to an existing account. The deposit is made by one of many different methods such as by cash, check, transfer, debit or credit card during a branch visit, by mail, Internet or telephone as indicated at 620.

The funds flow to a bank or non-bank clearing account at 630. This account is used by the financial intermediary to input amounts into its systems, and thus begin and end each day's business with a balance of $0. When an IBGC master account is established, funds flow from clearing account to IBGC master account as indicated at 640. While completing IBGC account application, when funds are deposited, or at a later time, the giftor or giftee selects allocation percentages or amounts to various available sub-account investment choices. A unique sub-account is established for each investment type that is selected. In this embodiment, the accounts include a liquid type of account 645 that is used for settlements. In this embodiment, the settlement account 645 is a money market account. There may be several such sub-accounts identified as “(a) [symbol] (zz)”. Other sub-accounts include several bond funds such as intermediate duration bond fund 650, long term bond fund 655, tax advantaged bond fund 660, inflation indexed fund 665 and other accounts indicated at 670. Each of these sub-accounts are referred to as investment accounts or sub-accounts, and each may also have several sub-accounts within them as identified by “(a) [symbol] (zz)”. They may be held or “custodianed” by an institution that is not the IBGC account creator.

In one embodiment, funds flow into the money market fund 645 from the investment accounts as indicated at block 675. Further, funds flow out of the money market account 645 to service IBGC giftee purchases. In one embodiment, the giftee initiates transfers of funds between investment and settlement accounts to ensure sufficient funds are available to pay for purchases. In further embodiments, rules are created either by the giftee or giftor to specify accounts to obtain funds from in order to settle purchases. In general, funds flow into the money market account fund to replenish or maintain a positive value in that account. Further rules may also be established as above regarding the allowed purchases that may be made.

Funds may optionally be transferred or flow from the money market account 645 to investment accounts to optimize return on the total value of the accounts. This may be accomplished by first transferring funds from the money market account back to the master account for distribution to the investment accounts, or directly from the money market account to the investment accounts.

While the example used in FIG. 6 discuss ed mostly bond type funds, stock funds, index funds, individual stocks and other investments may also be used as investment sub-accounts available for the IBGC.

### Conclusion

An account associated with the IBGC is credited on a predetermined basis with transaction related credits reflecting an effective monetary return on amounts maintained in the IBGC account. For example, the IBGC account can be credited with post-activation amounts reflecting a percentage of a transaction fee.

IBGC methods and system of the instant invention can be accessed through a variety of standard point of sale devices, through inter or intra-bank computer connections using existing bank debit networks, through connection with a personal computer or by telephone.

The IBGC is especially compatible with and designed for debit card, credit card and smart card processing systems in the United States. As explained hereinafter, the IBGC is an “isomer” of existing credit card systems and an improvement upon a retail gift card and a bank issuer's gift card. Whereas a credit line is granted at the outset and drawn down over time by the credit card user, the IBGC giftor (who may or may not be the same person as the IBGC giftee) provides funds that become the IBGC's available “credit line,” which are drawn down over time as purchases are made. Whereas interest accrues and is posted as a charge to be paid by the credit card account holder for an account balance that goes unpaid over time, interest accrues and is posted as a credit to be received by the IBGC holder for available credit that has not been drawn down or used over time.

The IBGC's interest attribute is a function of two properties, (a) average daily balance multiplied by some interest rate and/or (b) a sharing of a portion of the merchant's transaction fee, labeled for purposes of discussion as “Bonus Interest.” The two means of calculating interest make an IBGC available for use with bank or brokerage demand or checking accounts, Negotiable Order of Withdrawal (NOW) accounts, money market fund accounts and savings accounts.

The invention provides the giftor with a means to give a gift that (a) the giftee truly desires and (b) that does not depreciate over time. With the IBGC, the giftee receives interest on the gifted monetary balance and thus the giftee is incented to wait until the price is right or the appropriate gift becomes available for purchase rather than to act hastily and either possibly over-pay or not secure the ideal gift. Two simple examples explain the product's usefulness and appeal:

Christmas or holiday shopping time—An adult family member gives IBGCs to each of his children at Christmas time, the 25^{th} of December. Rather than pay for items prior to or during the height of the Christmas shopping season, the IBGC gives each giftee the chance to purchase items after the holiday has passed, when they are more likely to be selling at a lower price or on sale.

Wedding, new baby or first house—A father of the bride gives an IBGC to his daughter at the time of her wedding. That way, the new bride and her new husband are given an opportunity to purchase items that they truly desire, when they choose to. Until then, interest accrues and posts over time on the IBGC, so the father is assured that his monetary gift will not depreciate with time. The new baby comes along, and once again, the father of the bride can secure a new IBGC for his daughter, or he can add credit to the existing IBGC. Once again, the father's monetary gift can be used for what the new father and new mother desire to purchase when they make the effort to procure it. Until then, interest accrues and is posted to the IBGC so it does not depreciate with time.

The IBGC's nearly universal acceptance, because it is designed to be compatible with and acceptable for use on VISA®, MasterCard®, Discover® and American Express® card transaction networks, means that the giftor is assured that his monetary gift will be accepted for purchase transactions wherever the giftee chooses to use the IBGC.

The IBGC may be used in a number of permutations in order to satisfy particular giftor and/or giftee needs or desires as the American consumer becomes aware of the IBGC. For example, the giftor may desire airline miles in return for funding the IBGC using his available credit or debit card. Similarly, the giftee may prefer to receive some benefit in lieu of cash interest on a monthly basis as long as the IBGC credit balance is above 0 or some agreed upon minimum. Such benefits may include, among others, cash rebates, airline mileage points, charitable donations, purchase or service discounts.

Currently, the credit card issuer determines the amount of credit to grant the cardholder or user. For the IBGC issuer, that determination is made via the amount of funds, or credit, that are deposited with the IBGC issuer at the time the giftor applies for an IBGC. For example, the IBGC and related methods and systems of the instant invention can credit an IBGC account with transaction related credits. Such transaction related credits are supplemental (contractually determined) amounts reflecting an effective monetary return on amounts maintained in the IBGC account. Such payments are as a practical matter limited only by the constraints of local banking law and therefore can be effected in any number of ways. For example, the IBGC account could be credited with amounts reflecting a percentage of transaction fee paid by a merchant who transacts with a cardholder.

And, whereas, for the credit card account, interest is accrued for and becomes payable by the cardholder when an outstanding balance remains beyond a stated grace period, the IBGC account provides for interest to be received by that cardholder's account for credit that remains unused over a similarly stated and known grace period. Thus, the IBGC is an “isomer” of today's credit card.

The sharing of merchant transaction processing fees, done by credit card issuers to create product adoption and increase card usage, is another powerful tool to generate IBGC product awareness, growth and usage.

The following compares how the IBGC works from the issuer's perspective in relation to necessary accounting steps and highlights why the IBGC is an “isomer” of today's credit card.

For the credit card issuer:

STEP ONE Credit card issuer determines amount of credit to grant cardholder. The credit card issuer creates an electronic “Open to Buy” file that represents the amount of credit which may be drawn upon by the cardholder for some period of time, say a month.

STEP TWO Cardholder uses the credit card to purchase a good or service. The card issuer's “Open to Buy” file records the purchase as a debit, a reduction of the “Open to Buy” file's available credit.

STEP THREE Additional purchases are transacted over time and thus, the list of debits increases (until “Open to Buy” file debits equals credits, which means that the available card credit balance has been depleted to zero).

STEP FOUR At some point in time, say month's end, the credit card issuer accumulates the cardholder's debits in an activity statement and forwards that statement to the cardholder so issuer's purchase activity record may be reconciled with the holder's and payment for purchases may be made and received by the card issuer. The cardholder's payment is treated as a credit to the electronic file, or as an offset to the outstanding debits. If the payment received equals the amount of the issuer's record of outstanding debits, the cardholder's “Open to Buy” file is returned to its original credit value, i.e., the amount of credit that was authorized originally for purchase transactions.

STEP FIVE If the payment received is less than the accumulated debits, a debit balance remains on which a borrowing cost or “interest” may be accrued and posted to the credit card account, subject to the terms of the cardholder agreement. Such amounts are posted over time as debits, or as reductions to the cardholder's “Open to Buy” file.

For the IBGC issuer,

STEP ONE Giftor's transfer of funds to the IBGC card issuer determines amount of credit available to giftee's IBGC account. The IBGC issuer creates an electronic “Open to Buy” file that represents the amount of credit which may be drawn upon by the IBGC holder for some period of time, say a month.

STEPS TWO & THREE Same as for credit card issuer above (until “Open to Buy” file debits equals credits, which means that the IBGC available credit balance has been reduced to zero).

STEP FOUR At some point in time, say month's end, the IBGC card issuer accumulates the card user's debits in an activity statement and forwards that statement to the IBGC cardholder so IBGC card issuer's purchase activity record may be compared with IBGC cardholder's record.

STEP FIVE If the IBGC account's accumulated debit value is less than the original “Open to Buy” file's value, the IBGC holder ends statement cycle with an available credit balance. Interest is calculated on the available credit balance for that period of time, which is posted as a credit to (or as an increase of) the IBGC's “Open to Buy” value.

Thus, the IBGC employed in the instant invention differs from known debit or credit card in that the card account is an appreciating investment asset and the card may be used like a traditional credit or debit card throughout the banking network. An IBGC holder may dedicate the IBGC to the eventual purchase of an item whose cost exceeds an initial account activation balance, but which will become affordable when the IBGC balance reaches that cost. A third party such as an IBGC donor who has established the IBGC account for the benefit of the cardholder may, through the methods and systems of the instant invention, make supplementary deposits into the IBGC account. Through such activity, the IBGC system provided by the instant invention will engender a long-term relationship between the IBGC donor, cardholder and the IBGC sponsor bank.

Importantly, the IBGC used in the methods and systems of the instant invention is more secure than debit cards such as Smart Cards in that the IBGC itself does not contain any stored balance information. Further, because of the aforementioned attributes, the IBGC and related systems and methods will be widely accepted by retailers or service providers, in contrast to currently available debit cards. Numerous sponsors may participate in the IBGC system of the instant invention and funds relating to IBGC accounts may be readily transferred between such sponsors. Non-sponsors may also transfer funds into the system to establish an IBGC account, thereby making it convenient for customers of non-sponsors to become donors and establish IBGC accounts with sponsor institutions such as banks.

Retailers or service providers may encourage the use of the IBGC systems and methods of the instant invention by providing discounts on transactions in which payment is made using the IBGC or by crediting the IBGC holder with promotional benefits such as frequent flyer mileage. Use of the IBGC may increase the retailer or service provider's desired customer base by offering a guaranteed form of payment other than traditional credit cards. Thus, individuals who may not qualify for a credit card nonetheless may participate in cashless transactions through use of an IBGC in accordance with the instant invention.

Further, the instant invention enables existing credit or debit card networks, such as the VISA®, MasterCard®, Discover® or American Express® card networks, to add as component to such card networks the IBGC methods and systems of the instant invention and thereby enhance the value associated with related card accounts.

Thus, the invention provides an IBGC system comprising at least one IBGC encoded with a unique identification information including a number approved by the American Banking Association for use in a banking debit network. An IBGC sponsor processing hub computer under IBGC sponsor software control and in communication over a banking debit network with a seller's pre-existing, standard retail point of sale (POS) device (i) receives IBGC data when the IBGC is swiped through the POS device in a transaction. The IBGC data comprises the IBGC identification number, transaction amount, and account balance amount. The IBGC sponsor processing hub computer also has an IBGC account database corresponding to the IBGC. This IBGC account database comprises balance data representative of (1) the sum of an IBGC activation amount and transaction related or investment credits accrued by the IBGC account, less (2) amounts of current or previous transactions. Further, the IBGC sponsor processing hub computer also has an IBGC credit database under IBGC sponsor bank software control and in communication over an internal IBGC sponsor bank network with the IBGC account database for updating the IBGC account database on a predetermined periodic basis by transferring data reflecting IBGC transaction related or investment credits or amounts determined in accordance with IBGC account balance data.

What is claimed is:

1. A computer implemented method of interacting with a gift card, the method comprising:
receiving funds for deposit in a gift card account;
transferring the funds to one or more investment sub-accounts in the gift card account;
settling transactions from a settlement sub-account; and
calculating a value of all sub-accounts in the gift card account.

2. The method of claim 1 wherein the settlement sub-account comprises a money market account.

3. The method of claim 1 wherein the investment sub-accounts comprise bond funds.

4. The method of claim 1 wherein the bond funds are selected from the group consisting of intermediate duration, long term, tax advantaged and inflation indexed bond funds.

5. The method of claim 1 wherein the value of the sub-accounts is calculated based on net asset value.

6. The method of claim 1 wherein the value of the sub-accounts is calculated after market close each day.

7. The method of claim 1 wherein funds are transferred to the settlement sub-account from predetermined other investment accounts to cover transaction settlements.

8. The method of claim 1 and further comprising receiving and executing instructions from a giftee of the IBGC related to transferring funds between sub-accounts.

9. A computer implemented method of interacting with a gift card, the method comprising:
receiving funds for deposit in a gift card account;
placing the received funds in a clearing account;
allocating the funds from the clearing account to one or more investment sub-accounts in the gift card account;
settling transactions from a settlement sub-account; and
calculating a value of all sub-accounts in the gift card account.

10. The method of claim 9 wherein the funds are received from a giftor to establish a gift card account or to renew funds in an existing gift card account.

11. The method of claim 9 and further comprising:
receiving gift card data when the gift card is used to attempt to make a purchase; and
applying a filter based on information provided independent of a recipient of the gift card to reject selected transactions.

12. The method of claim 11, wherein the filter comprises comparing a merchant from whom the purchase is attempted to a list of approved merchants.

13. The method of claim 11, wherein the filter comprises comparing a merchant category corresponding to the merchant from whom the purchase is attempted to a list of approved categories.

14. The method of claim 11, wherein the filter comprises using a maximum transaction value that cannot be exceeded.

15. The method of claim 11, wherein the filter comprises comparing a merchant from whom the purchase is attempted to a list of approved merchants and using a maximum transaction value that cannot be exceeded.

16. The method of claim 15 wherein each merchant has an associated maximum transaction value.

17. A computer system for interacting with a gift card, the system comprising:
a module that processes received funds for deposit in a gift card account;
a module that maintains account information for multiple investment sub-accounts;
a module that transfers the funds to one or more of the maintained multiple investment sub-accounts in the gift card account;
a module that settles transactions from a settlement sub-account; and
a module that calculates a value of all sub-accounts in the gift card account.

18. A computer implemented method of interacting with a gift card, the method comprising:
receiving gift card data related to an attempted transaction using a gift card having multiple associated investment accounts, including a settlement sub-account;
ensuring sufficient funds are available to settle the transaction; and
settling the transaction from a settlement sub-account.

19. The method of claim 18 and further comprising calculating a value of all sub-accounts in the gift card account.

20. The method of claim 19 wherein the value of the sub-accounts is calculated based on net asset value (NAV).

21. The method of claim 19 wherein the value of the sub-accounts is calculated after market close each day.

22. The method of claim 19 wherein funds are transferred to the settlement sub-account from predetermined other investment accounts to cover transaction settlements.

23. The method of claim 18 wherein the settlement sub-account comprises a money market account.

24. The method of claim 18 wherein the investment sub-accounts comprise bond funds.

25. The method of claim 24 wherein the bond funds are selected from the group consisting of intermediate duration, long term, tax advantaged and inflation indexed bond funds.

26. A computer implemented method of interacting with a gift card, the method comprising:
receiving gift card data related to an attempted transaction using a gift card having multiple associated investment accounts, including a settlement sub-account;
applying a filter based on information provided independent of a recipient of the gift card to approve selected transactions; and
settling the transaction from a settlement sub-account if the transaction is approved by the filter.

27. The method of claim 26, wherein the filter comprises comparing a merchant from whom the purchase is attempted to a list of approved merchants.

28. The method of claim 26, wherein the filter comprises comparing a merchant category corresponding to the merchant from whom the purchase is attempted to a list of approved categories.

29. The method of claim 26, wherein the filter comprises using a maximum transaction value that cannot be exceeded.

30. The method of claim 26, wherein the filter comprises comparing a merchant from whom the purchase is attempted to a list of approved merchants and using a maximum transaction value that cannot be exceeded.

31. The method of claim 30 wherein each merchant has an associated maximum transaction value.

32. An interest bearing gift card (IBGC) system comprising:
at least one IBGC encoded with information including a unique identification number approved by the American Banking Association for use in a banking debit network;
an IBGC sponsor processing hub computer under IBGC sponsor software control and in communication over a banking debit network with a seller's pre-existing, standard retail point of sale (POS) device, said IBGC sponsor processing computer (i) receiving IBGC data when said IBGC is swiped through said POS device in a transaction, said IBGC data comprising the IBGC identification number, transaction amount, and account balance amount, (ii) having an IBGC account database corresponding to said IBGC, said IBGC account database comprising balance data representative of (1) the sum of an IBGC activation amount and transaction related or investment credits accrued by the IBGC account, less (2) amounts of current or previous transactions, and (iii) having an IBGC credit database under IBGC sponsor bank software control and in communication over an internal IBGC sponsor bank network with the IBGC account database for updating said IBGC account database on a predetermined periodic basis by transferring data reflecting IBGC transaction related or investment credits on amounts reflected by said IBGC account balance data; and
a plurality of investment sub-accounts over which the balance may be distributed.

33. A method of using an interest bearing gift card (IBGC) in connection with a transaction, comprising:
swiping the IBGC through a seller's pre-existing, standard retail point of sale (POS) device to transmit IBGC data to an IBGC sponsor processing hub computer under IBGC sponsor software control and in communication over a banking debit network with the POS device, said IBGC data comprising (i) unique IBGC identification information including a number approved by the American Banking Association for use in a banking debit network and (ii) a transaction amount;
accessing an IBGC account database corresponding to the IBGC and maintained on the IBGC sponsor processing hub computer, the IBGC account database comprising balance data representative of (1) the sum of an IBGC account activation amount and transaction related or investment credits accrued by the IBGC account, less (2) amounts of previous transactions;
calculating the difference between the transaction amount and the IBGC balance data using the IBGC sponsor processing hub computer and (i) if such difference is a sufficiently large positive number, transmitting data from the IBGC sponsor processing hub computer to said POS authorizing the transaction, or (ii) if such difference is not a sufficiently large positive number, transmitting data from the IBGC sponsor processing hub computer to the POS denying the transaction;
updating the IBGC account database using the IBGC sponsor processing hub computer to transmit data to the IBGC account database reflecting (i) the subtraction from the IBGC balance of the amount of an authorized transaction, and (ii) the addition to the IBGC balance of IBGC transaction related or investment credits; and
transferring funds from an investment account in the IBGC account database corresponding to the IBGC to a settlement account in the IBGC account database corresponding to the IBGC.

34. An interest bearing gift card (IBGC) adaptable for swiping through a seller's pre-existing, standard retail point of sale (POS) device to transmit IBGC data to an IBGC sponsor processing hub computer under IBGC sponsor software control and in communication over a banking debit network with the POS device, said IBGC data comprising (i) unique IBGC identification information including a number approved by the American Banking Association for use in a banking debit network and (ii) a transaction amount, said IBGC thereby accessing an IBGC account database corresponding to said IBGC and maintained on the IBGC sponsor processing hub computer, said IBGC account database comprising balance data representative of (1) the sum of an IBGC account activation amount and transaction related or investment credits accrued by the IBGC account, less (2) amounts of previous transactions, said IBGC sponsor processing hub computer thereby calculating the difference between the transaction amount and the IBGC balance data to determine (i) if such difference is a sufficiently large positive number, in which case said IBGC sponsor processing hub computer transmits data to said POS authorizing said transaction, or (ii) if such difference is not a sufficiently large positive number, said IBGC sponsor processing hub computer transmits data to said POS denying said transaction, wherein the IBGC account database uses the IBGC sponsor processing hub computer to transmit data to the IBGC account database reflecting (i) the subtraction from the IBGC balance of the amount of an authorized transaction, and (ii) the addition to the IBGC balance of IBGC transaction related or investment credits, wherein the balance data comprises values of multiple different investment sub-accounts corresponding to the IBGC account.

35. A method of interacting with a gift card encoded with information including a unique identification number for use in a banking debit network the method comprising:
receiving gift card data when the gift card is used to make a purchase;
maintaining a gift card account database comprising the gift card's identification number, transaction amount, and account balance data representative of the sum of a gift card activation amount and transaction related or investment credits accrued by the gift card account comprising multiple investment sub-accounts, less amounts of current or previous transactions; and
updating the gift card account database on a predetermined periodic basis by transferring data reflecting gift card transaction related or investment credits on amounts reflected by the gift card account balance data.

36. The method of claim 35 wherein the account balance data is calculated based on a net asset value measurement of the sub-accounts.

37. The method of claim 35 wherein the account balance data is calculated based on the net market portfolio value of the sub-accounts.

38. A system for interacting with a gift card encoded with information including a unique identification number for use in a banking debit network the method comprising:
means for receiving gift card data when the gift card is used to make a purchase;
means for maintaining a gift card account database comprising the gift card's identification number, transaction amount, and account balance data representative of the sum of a gift card activation amount and transaction related or investment credits accrued by the gift card account comprising multiple investment sub-accounts, less amounts of current or previous transactions; and
means for updating the gift card account database on a predetermined periodic basis by transferring data reflecting gift card transaction related or investment credits from the multiple investment sub-accounts on amounts reflected by the gift card account balance data.
